(19) United States
(12) Patent Application Publication
(10) Pub. No.: US 2007/0033269 A1
(43) Pub. Date: Feb. 8, 2007

(54) Computer method and apparatus using embedded message window for displaying messages in a functional bar

(76) Inventors: Gregory Orland Atkinson, Winter Park, FL (US); Michael Noel Hu, Timberlea (CA)

Correspondence Address: YING CHEN, 255 S. GRAND AVE., # 215, LOS ANGELES, CA, 90012, US

(21) Appl. No.: 11/496,963

(22) Filed: Jul. 31, 2006

Related U.S. Application Data
(60) Provisional application No. 60/703,722, filed on Jul. 29, 2005.

(51) Int. Cl. G06F 15/16

(52) U.S. Cl. 709/219

(57) ABSTRACT

A computer-implemented method employs message windows in a functional bar (e.g., toolbar, status bar, address bar, task bar, etc.) embedded in a software program to display messages (including text, images, animation, video, audio, etc.), where the messages displayed in the windows are based on searches conducted by the user. The software program in which the windows are embedded may be a browser or non-browser application. The messages displayed in the windows are downloaded from a server connected to the computer. In one embodiment, the messages are downloaded when the computer is connected to the server and stored on the computer, and later displayed in the message windows when the computer is not connected to the server. The method can be used to display advertisement or to allow organizations to communicate with their constituents. The method allows advertisers and organizations to select subgroups of users to direct their messages to.

### CROSS-REFERENCE TO RELATED APPLICATION

This application claims priority from U.S. Provisional Application No. 60/703,722, filed Jul. 29, 2005, which is incorporated by reference herein in its entirety.

### BACKGROUND OF THE INVENTION

This invention relates to computer programs, and in particular, it relates to a program for displaying information to a user using windows embedded in a functional bar of another program.

### SUMMARY OF THE INVENTION

Toolbars of software programs have been used to provide a variety of functions for the user and for displaying information to the user.

A computer-implemented method according to embodiments of the present invention employs message windows in a functional bar (such as toolbar, status bar, address bar, task bar, etc.) embedded in a software program to display messages (including text, images, animation, video, audio, etc.), where the messages displayed in the message windows are based on searches conducted by the user. The software program in which the functional bar is embedded may be a browser application or a non-browser application. The messages that are displayed in the message windows are downloaded from a server connected to the computer via a network. In one embodiment, the messages are downloaded when the computer is connected to the server and stored on the computer, and can be later displayed in the message windows when the computer is not connected to the server. The method can be used to display advertisement or to allow organizations to communicate with their constituents. The method also allows advertisers and organizations to select subgroups of users to direct their messages to.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a method implemented on a computer for displaying information to a user, which include the following steps: (a) creating a functional bar area associated with a main window of an application program, the functional bar area including at least one message window; (b) connecting the computer to a server via a network; (c) in response to a user input of a search term, forwarding a search request to the server; (d) receiving search results responsive to the search request and additional messages from the server, the additional messages having been selected by the server based on the search request; (e) displaying the search results to the user; and (f) displaying the additional messages in the message window in the functional bar area.

In another aspect, the present invention provides a method implemented on a system including a server and one or more client computers connectable to the server via a network, the method including the following steps: on each client computer, (a) creating a functional bar area associated with a main window of an application program, the functional bar area including at least one message window; (b) connecting the computer to the server via the network; (c) in response to a user input of a search term, forwarding a search request to the server; (d) receiving search results responsive to the search request and additional messages from the server, the additional messages having been selected by the server based on the search request; (e) displaying the search results to the user; and (f) displaying the additional messages in the message window in the functional bar area; and on the server, (g) obtaining and storing a plurality of messages from a plurality of message senders; (h) receiving a search request from a client computer; (i) obtaining search results responsive to the search request; (j) selecting, from the plurality of stored messages, a subset of messages based on the search request; and (k) transmitting the search results and the subset of messages to the client computer.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates an application window containing search result and a message window in the toolbar according to an embodiment of the present invention.

FIG. 2 illustrates a message window in a toolbar having an increased size.

FIG. 3 illustrates two message windows in a toolbar.

FIG. 4 illustrates message windows used for video conferencing.

FIG. 5 illustrates a message window used for personal messages.

FIGS. 6(a)-(c) illustrate an EazyHunt Hover operation.

FIG. 7 illustrates a system implementing EazyMessage according to an embodiment of the present invention.

FIG. 7(a) illustrates a process by which a software developer integrates EazyMessage into a software product.

FIG. 7(b) illustrates a process by which an advertiser delivers advertisement using EazyMessage.

FIG. 7(c) illustrates a runtime interaction sequence of integrating EazyMessage into a third party software product.

FIG. 8 illustrates a process by which the EazyMessage library interacts with the user and the EZM website to deliver ads to the user and to facilitate the user's interaction with the advertiser.

FIG. 9 illustrates a process that integrates a search and the message delivery.

### DETAILED DESCRIPTION OF THE PREFERRED EMBODIMENTS

Various embodiments of the present invention are described below. In the following descriptions, the names “EazyMessage,” “EazyMessagePersonal,” EazyHunt, EazyHunt Hover, EazyReminder, etc. are used as a convenient way of referring to these embodiments, and it should be understood that the names themselves do not in any way limit the scope of the embodiments. All of these embodiments are implemented on a programmed computer.

EazyMessage

EazyMessage is a computer-implemented method of delivering messages to a user within an existing software program. EazyMessage downloads, filters, and displays messages to users through its window. The messages may be any type of communication in nature, including but not limited to advertisement, messages from providers of service that the user of the computer subscribes to, messages from any sources that the user consents to receiving communication from, message originating from the computer itself, search results, etc. EazyMessage employs an embedded window to display messages. The window in which the messages are displayed is embedded in a functional bar of a software program (either an application or the operating system), such as a toolbar, a status bar, an address bar, a taskbar, etc. Alternatively, the message may also be displayed or in a popup window, or in any other screen location of the program or operating systems. EazyMessage can be displayed in any size or shape in the bar. The message display may be either static or dynamic, e.g., it may include video streaming, audio, and other effects. The program can cycle through the messages and ads without user intervention.

In one preferred embodiment, EazyMessage is implemented as a software library (such as an ActiveX control, dll, etc.) which can be integrated into any software using standard techniques of hosting ActiveX controls within a program. This makes it possible to deploy EazyMessage in any software environment, such as Internet browser, word processing, spreadsheet software, presentation software, email software, multimedia software, video streaming software, gaming software, educational software, operating system software, etc. or any other software that can incorporate a window.

More specifically, most, if not all windowing programming environments support the notion of a “software component.” A software component is a library that can be embedded within another program, usually on a visual basis. Components are also usually implemented as a window, causing them to be a “window within a window.” This “window-within-window” paradigm allows the component to react to user events (such as mouse clicks) that are performed within the window, no matter which parent window hosts the component. Exactly how a software developer adds a component to his program is specific to each programming environment, but supporting the notion of embedding a third party library (like EazyMessage) into a program and having it react to user mouse clicks is sufficient to implements the message window according to embodiments of the present invention. This capability is generally available across all consumer operating systems. For example, the inventors of this invention have integrated EazyMessage into Microsoft® Word, by using an interface provided by Microsoft® for third party developers to integrate the libraries into Word.

In one practical application, EazyMessage is deployed into a functional toolbar to display advertisement as an added source of revenue for toolbar creators. EazyMessage is not a solely devoted advertising window, instead EazyMessage augments the experience for the computer user as a “message window.” For example, a user may send a visual message to another user who has an EazyMessage window installed in her software package.

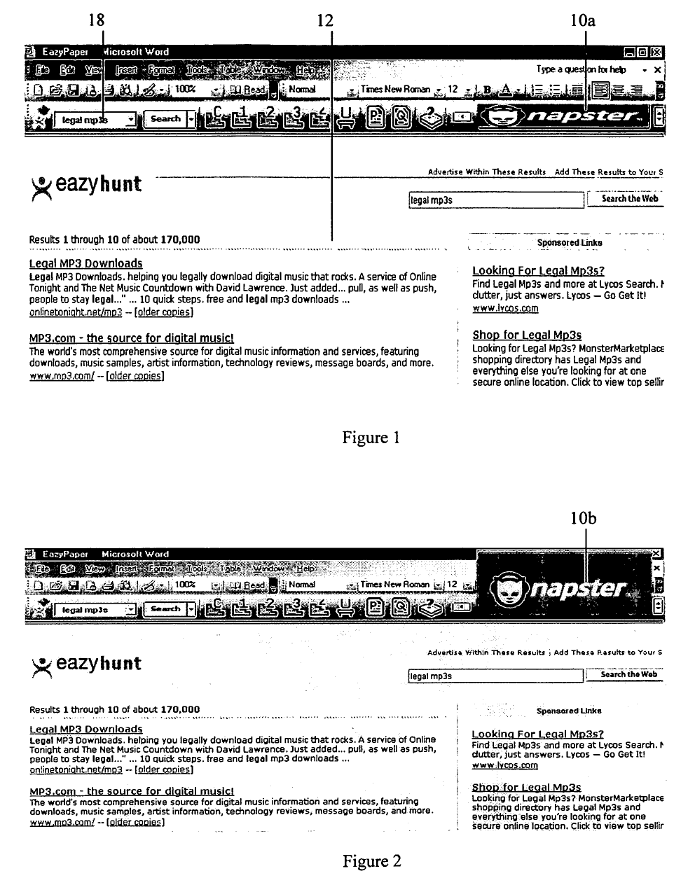

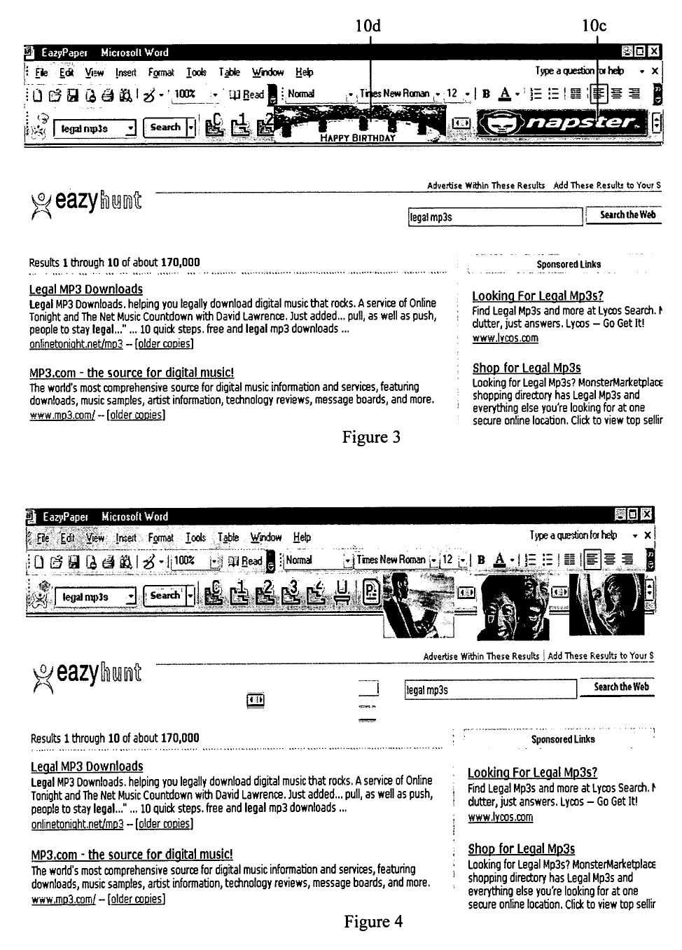

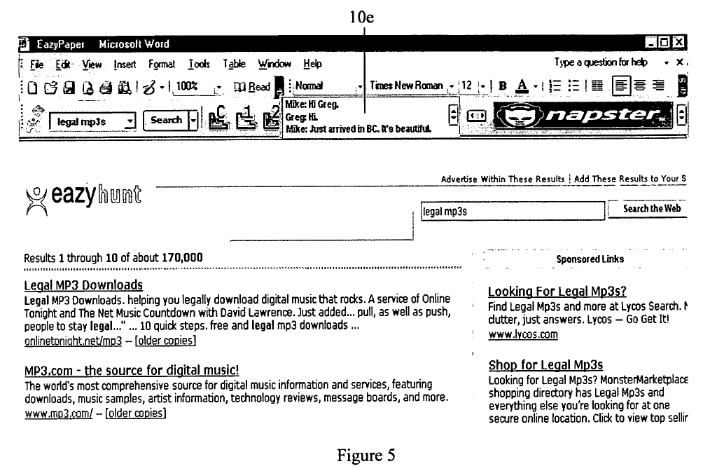

EazyMessage allows the user to control the size, number, and location of additional, simultaneous EazyMessage windows. FIGS. 1 and 2 illustrates EazyMessage windows 10a and 10b having different sizes. The user can change the size of the message window by selecting the arrows to the right of the message window 10b as seen in FIG. 2. The EazyMessage software can control the appearance of the message windows. As shown in an example in FIG. 1, the main area 12 of the application window displays the search result of an EazyHunt search (described later), and a visual message is also returned in the EazyMessage window 10a. If the computer user was using their EazyMessage window for something else, their previous EazyMessage window would stay open and another EazyMessage window would open, rolling over to make space. The user also has the option of isolating one EazyMessage window at a time by selecting from the down arrow to the right of the EazyMessage window 10a as seen in FIG. 1. The user can roll over windows to the left by selecting the arrow to the left of the EazyMessage window. This can be done in any size of EazyMessage window, and the user can control the size of the EazyMessage window in pixels. The user then is provided two arrows to the left of the original EazyMessage. This allows the user to open or close additional EazyMessage windows. Two EazyMessage windows 10c and 10d are seen in FIG. 3. The first EazyMessage window 10c was provided as a search engine result, and the second EazyMessage window 10d was sent to the user by a family member wishing the computer user a Happy Birthday in the example shown in FIG. 3. All of these EazyMessage windows can be open simultaneously while the user is in another program environment doing other work. This is possible because EazyMessage supports user configuration of its user interface (UI). The detailed functional specification and design specification for this feature is not described here because techniques for accomplishing this feature are familiar to those skilled in the programming art.

A message displayed in an EazyMessage window can be displayed anywhere on the desktop, by “tearing-off” (e.g., by clicking and dragging) an EazyMessage window to a desired location on the screen. The “torn-off” window is a floating window, and the place where it was torn off becomes another EazyMessage window. The “torn-off” window may be implemented as a cloned window of the original EazyMessage window. All modern windowing operating systems support the cloning of windows.

When the EazyMessage window displays an ad, the user may choose to respond to the ad if she wishes. When the user clicks on a message in the EazyMessage window, the EazyMessage program directs the user to a website of the advertiser. Thus, a separate webpage appears where the user can learn more information about the product or service being advertised, or get more detailed information about the message being displayed. The original window is not reduced in size, and remains the primary window. Alternatively, but less preferred, EazyMessage may show non-interactive ads which does not allow the user to click through. A disadvantage of this alternative is the lack of a way to track the effectiveness of an ad campaign or to generate advertising revenue on a per click basis.

EazyMessage may be implemented as a software library, and can be implemented on any hardware platform, such as PCs, Macs, cell phones, etc., and any operating system (OS). On the backend, being a library allows EazyMessage to be integrated anywhere in an application programs or OS, and not restricted to a toolbar or an Internet browser. This allows developers of third-party software to easily integrate EazyMessage into their applications. In one preferred embodiment, the EazyMessage implementation is an ActiveX component, which will work for all Windows environments (including Windows CE for mobile and low resource computing). Other embodiments include Microsoft.NET assembly, a Linux dll, or Mac library, or other library mechanism.

Alternatively, instead of a library, EazyMessage may be coded as a separate program which launches in its own window. A disadvantage of the separate program implementation is poor integration. It is also difficult to collect demographic data to filter the ads. As another alternative, instead of a library, EazyMessage may be directly coded for a program. A disadvantage of the direct coding implementation is that each developer would have to design and develop the client, server, and ad network for himself. There would be no way of sharing the server and network between programs, and advertisers would have to sign up for each network separately

EazyMessage can be used in many different kinds of practical applications. Some examples are:

i. Messaging in real time between friends or colleagues at work. Unlike other pop-up functions, EazyMessage allows the user to have a steady flow of contained messages, in a non-intrusive, non-interruptive environment.

ii. Messaging static messages between computer users. Computer users can send or receive unique visual messages such as a greeting card, photographs, or any other image. EazyMessage supports static images as well as flash presentations.

iii. Video Streaming. This allows the computer user to work on the Internet and view video streaming simultaneously.

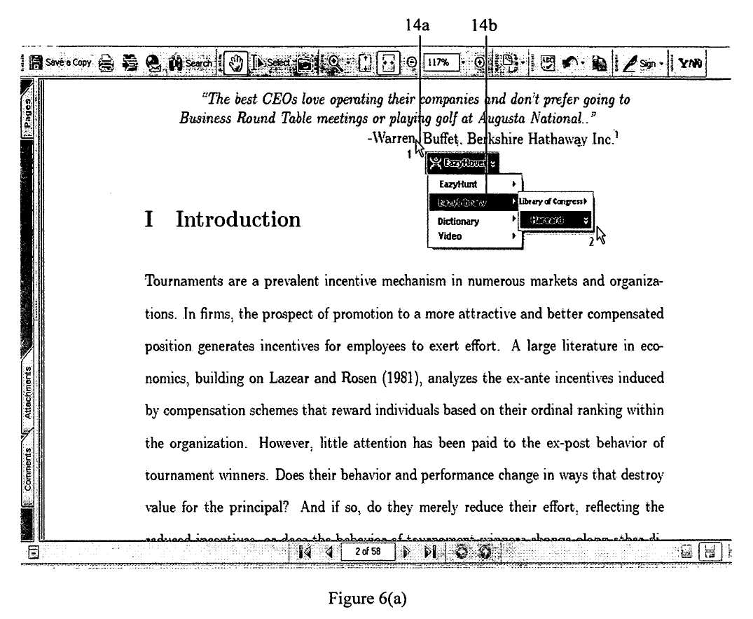

iv. Video Conferencing. This allows the computer user to participate in a virtual conference and have a full screen to view files, or Internet content that is being presented in their conference. This can also have application for friends or family wishing to video conference and simultaneously view files, or information on the Internet without having their screen interrupted. Again the user can have multiple EazyMessage windows open simultaneously allowing the user to video conference with as many people as they wish. To accommodate larger conference calls EazyMessage provides a “rollover” arrow in the EazyMessage bar that rolls extra EazyMessage windows over other task buttons in the bar. FIG. 4 shows an example of EazyMessage used to provide video conferencing. The user controls the size and position of each conference member.

v. Search engine results in EazyMessage window allows users to view results in a more appealing environment. When computer users conduct a search using a search engine integrating the EazyMessage technology, results will not only be returned on the computer screen but also selected results are returned in EazyMessage.

Several specific applications of EazyMessage, namely, EazyMessagePersonal, EazyHunt, EazyHunt Hover, and EazyReminder are described in more detail below.

EazyMessagePersonal

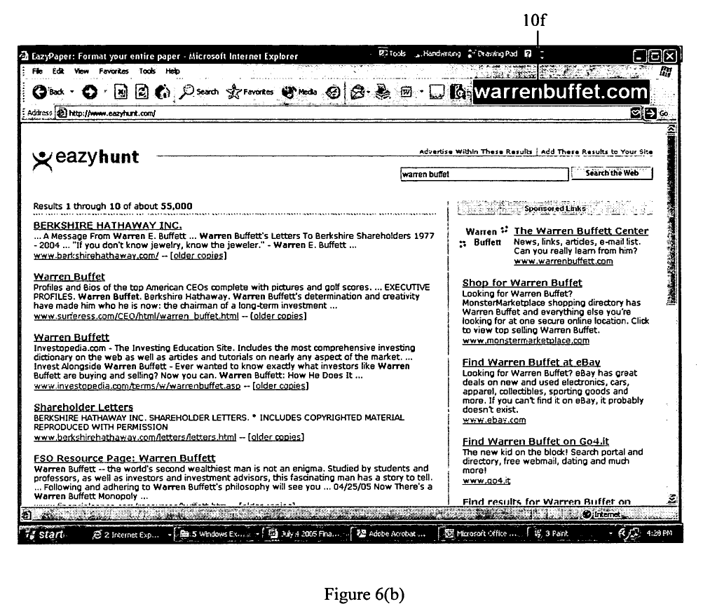

EazyMessagePersonal is an add-on to EazyMessage that allows a user to send a personal message to another EazyMessagePersonal user or group of users. FIG. 5 illustrates an EazyMessage window 10e used for personal messages. This is done by the sender using the EazyMessage Control Panel. The sender selects the pre-produced message they would like to send, or chooses to create their own message, and then inputs their name, email address, and any specific message they would like to send. The sender then inputs the name and email address of the recipient. If the recipient currently has EazyMessage the receiver will be notified that they have received an EazyMessage from the sender. The sender will be identified by name and email address. If the receiver clicks to view the message, their personalized EazyMessage will appear. If they do not accept to view their EazyMessage, the EazyMessage is not sent/broadcast. If the receiver does not have EazyMessage activated, EazyMessage automatically sends an email to the receiver alerting them to the fact that they have been sent an EazyMessage from the sender (with name and email of sender included in the email). The receiver is given the option of either viewing their EazyMessage online at a designated webpage or downloading and viewing their message in EazyMessage.

EazyMessagePersonal provides several events to trigger a message. Through the online control panel, a user can configure EazyMessagePersonal to display a message during a certain time of day, or whenever a user browses to a specific website. When the message recipient launches his browser with the EazyMessage-enabled toolbar installed, the toolbar contacts the message server to query pending messages. The toolbar can then react to user or clock generated events to display the message. A specific example is described below. User A sets a message to User B asking him a particular question. Knowing that User B frequents a particular website, User A sets the message to display whenever User B browses to that website during a certain time of the day, e.g. just before User B comes home from work. When User B launches his browser, which initializes the EazyMessage-enabled toolbar. The EazyMessage library contacts the EazyMessage server and downloads the message to User B's computer. Then, when User B browses to the particular website, the EazyMessage-enabled toolbar detects that User B has browsed to that website (modern browsers have APIs that allow embedded toolbars to receive browsing events), and checks that the time is during the preset time of day from the computer's clock. EazyMessage then displays User A's message to User B. EazyMessagePersonal can also be used as a reminder function, because a user can send an EazyMessage to herself (see more description below). That message can be displayed on a time-based and/or website-based policy.

Upon the first message from a sender, the receiver has the option to “Accept, Block, or Decide Later” messages from the sender. “Accept” will accept all messages from that sender, “Block” will block all messages from that sender, and “Decide Later” will defer the decision until later. If the receiver accepts the sender, the message will be displayed in the receiver's EazyMessage window. A sender can also configure EazyMessagePersonal to message a receiver whenever the sender logs onto a website or program. Receivers can assign separate ringtones to each sender to identify the person who sent the message.

EazyHunt

EazyHunt provides search capability integrated into a toolbar of an application or operating system program. In the example shown in FIG. 1, search terms are entered into a window 18 on a toolbar. The EazyHunt search engine may have its own webpage to perform the search. EazyHunt and EazyMessage may be linked together so that when a user conducts a search using EazyHunt, the EazyMessage window then provides content (such as advertisement) that is related to the user's search. In one preferred embodiment, advertisement is provided based on the last EazyHunt search a user conducted. In the example shown in FIG. 1, the main area 12 of the application window displays the search result of an EazyHunt search, and a message is also returned in the EazyMessage window 10a. Here, the message (Napster) is an advertisement related to the user's EazyHunt search (“legal mp3s”).

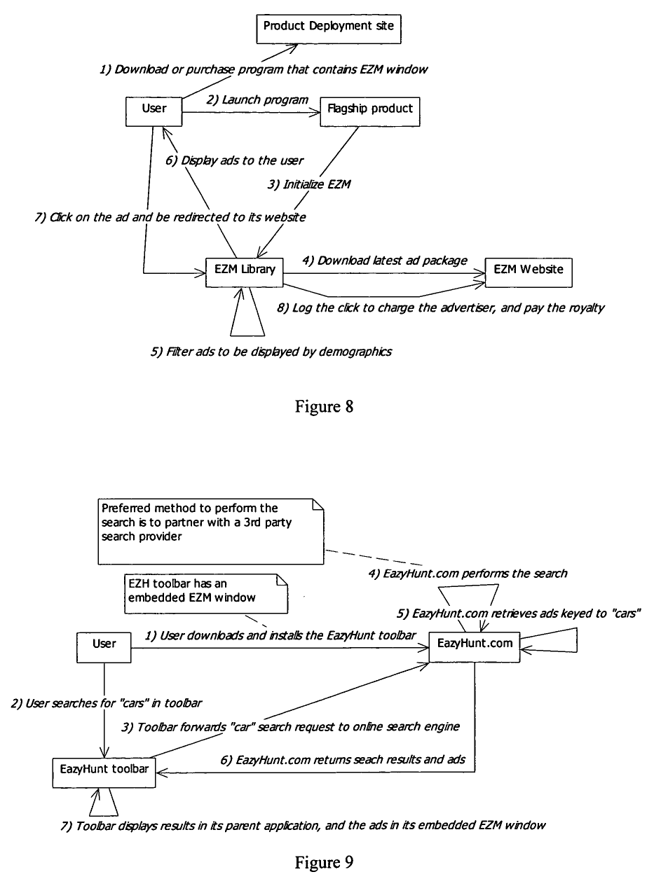

FIG. 9 illustrates a process that integrates EazyHunt and EazyMessage. First, the user downloads and installs the EazyHunt toolbar from a vendor, and the EazyHunt toolbar is integrated into the user's browser (step 1). The user enters a search term in the toolbar, (“cars” in this example), and clicks search in the toolbar (step 2). EazyHunt toolbar forwards the search term to an online search engine (step 3). The search engine performs the search, or forwards the search request to a third party search provider (step 4). The search engine retrieves the ads that are keyed to the user's search term (step 5). The search engine returns the search results and ads to the EazyHunt toolbar (step 6). EazyHunt toolbar (which is integrated into the a browser in this example) displays the search results in the user's browser. EazyHunt will also display the ads keyed to that search term in the EazyMessage window (step 7). In step 7, the EazyHunt toolbar calls the API functions of the browser to display the search results as a webpage.

As mentioned earlier, EazyMessage (and hence EazyHunt) can be present in any environments (word processing, presentation, spreadsheet, email, video, audio, or any other environment/application) because they are in a bar of the application. If a user conducts a search in EazyHunt while in a word processing environment and then closes their word processing environment and opens a spreadsheet, EazyMessage will still provide content that is relevant to their search conducted in the word processing environment. In other words, the choice of which messages to display in an EazyMessage window is persistent across multiple software environments. To achieve this, the EazyHunt toolbar will not only display the search-term specific ads in its EazyMessage window, but also cache that ad (which is a simple graphic file, like .gif, .jpg, etc.) in its image repository. Other applications that have an EazyMessage window will always take its images/ads from this shared repository. Thus, all EazyMessage enabled applications will pick up the new image/ad from the repository and display it to the user. This allows advertising results to be persistent and displayed to all EazyMessage enabled applications. This ad will continue showing until a new EazyHunt search request offers up a new ad.

EazyHunt Hover

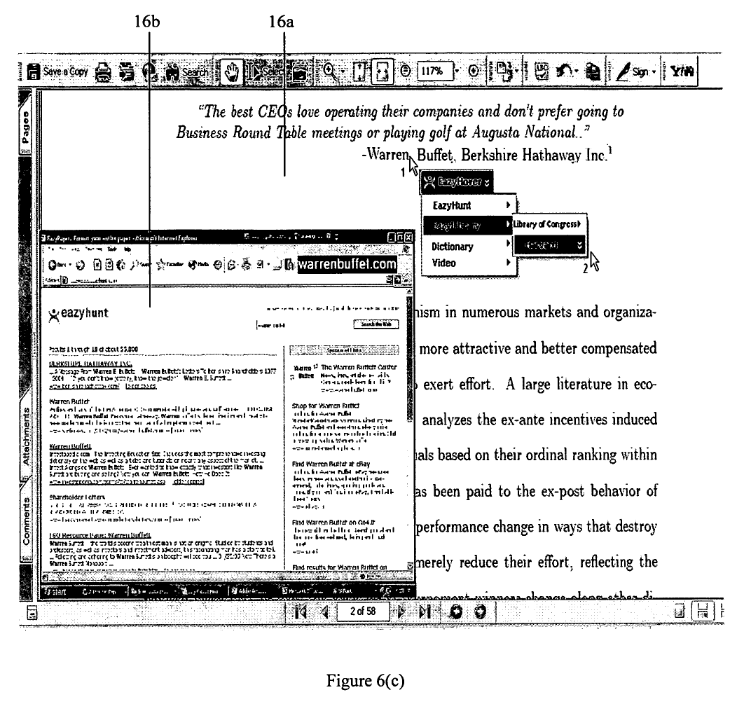

EazyHunt Hover is a context-sensitive popup interface to the EazyHunt toolbar. It performs a search for the term underneath the paused mouse cursor. EazyHunt Hover allows the user to conduct a search in any environment (word processing, spreadsheet, presentation, internet browser, email, the operating system, etc.) without opening an Internet browser or a new Internet window, or closing their current environment. As shown in FIG. 6, the user hovers the mouse over the content (text, image, graphics, video, etc.) as indicated by reference number 14a. EazyHunt Hover reads the text under the mouse cursor, which can be done using APIs provided by the operating systems. When a user hovers over images, EazyHunt Hover reads the code behind the image and automatically selects the most obvious search term. If there are multiple terms that are suitable for searching, EazyHunt Hover will ask the user to choose which term they wish to select. If the user clicks immediately after moving the mouse over the content, EazyHunt conducts a general Internet search. If the user hovers the mouse and waits just a fraction of a second, a drop down menu 14b appears, asking the user how they would like to conduct her search. Various search tools may be made available in this drop down menu; the menu may also include dictionary, thesaurus, atlas, and other reference tools. For example, EazyHunt Hover may send the search request to the EazyHunt toolbar to conduct the search. The user can set the search to more specific parameters, or search subjects such as entertainment, sports, science, health, etc.

When the user selects how she wished to conduct her search, a search is conducted and an Internet browser pops up with the search results, as shown in FIG. 6(b). Their original computer screen does not disappear, and the computer user can choose to have their results pop up quarter-screen, half-screen, full screen, or customize the size to their own choosing. Examples of search result windows are shown in FIG. 6(b) (full screen) and FIG. 6(c) (where the search result window 16b is on top of the original application window 16a). EazyHunt Hover can also be linked to EazyMessage so that an EazyMessage window provides content (e.g. advertisement) that is relevant to the user's search content (such as the window 10f in FIG. 6(b)). In other words, EazyHunt Hover may perform the same steps as steps 3-7 performed by EazyHunt as illustrated in FIG. 9.

EazyHunt further saves time and space for the user by bringing back the search results and providing these results with EazyPeek. EazyPeek allows the user to hover over the search results and with a right click of their mouse have a small window open that offers a peek of the webpage correlating with the specific search result being hovered over. This allows the user to have a peek at the webpage and determine if this content is of value. This saves the user from having to click into a webpage and then click back to their search results. EazyHunt also allows the user to save specific search results into their EazyDataBase by simply checking off a box in the search results of EazyHunt. The user creates specific folders that allow quick recall of past search results. The EazyMessage window provides content that is relevant to their search content. When a user hovers over images the EazyHunt Hover technology reads the code behind the image and selects the most obvious search term. If there are multiple terms EazyHunt Hover will ask the user to choose which term they wish to select.

The EazyHunt Hover feature may be implemented independent of the EazyMessage windows, and used by itself as a convenient way of conducting a search.

EazyReminder

The EazyMessage technology can also be used to provide the user a reminder function, EazyReminder. EazyReminder utilizes the EazyMessage technology in that a user can create their own playlist of reminders or todo list, and EazyMessage will send appropriate messages to the user as scheduled. Their EazyReminder playlist can be global (i.e. played in all environments), unique to an environment (for example, the user may have a separate EazyReminder playlists for word processing, spreadsheet, presentation, video, etc.), or specific to a file. EazyReminder allows users to specify where their reminders will be displayed—file-specific, application specific, or global. The user can also set the time and frequency of the reminders (such as every 15 minutes, every hour, on the 15th of each month, annually, etc.). EazyReminder may have a ringtone played when the scheduled reminder is triggered.

As an example of a file-specific reminder, a user can create a todo list for a school paper. The user sets deadlines for the completion of each phase of the paper, and uses EazyReminder to keep on track of progress. She can open the EazyReminder menu and create a series of reminders to keep the process of the paper on schedule, by entering the dates, frequency, and content of the reminders. The reminder messages appear at the times programmed by the user. The user can check off the items on their todo list as they are completed. The user will see this EazyReminder campaign only when she opens the file that relates to the specific school paper.

Another way to generate reminders is that EazyReminder allows a user to set a default message with any participating third parties (company, organization, club, etc.) (EazyReminder third party reminders). A third party (e.g., a company, organization, or club to which the user belongs) can add its special reminders to the list on a user's EazyReminder by providing a customized EazyReminder installer. The user can also login to the website of a third party, and click an opt-in feature allowing this organization to send her reminders of events, payments, etc. Whether the reminders originate from the user herself or a third party, the user can always control the reminders being generated.

In addition, a user can also enable EazyReminder to alert them when a friend, family member, colleague, etc. has logged on the Internet, currently has an Internet connection but is not active on the Internet, or can be alerted when they enter any specific site, or program. The user can be notified by an EazyReminder message, an EazyReminder tune that is specific for each user, or both an EazyReminder message and an EazyReminder tone.

The EazyReminder feature may be used to generate any kind of reminder list. An example is a shopping list. The user can send this shopping list to her cell phone. The user then views their EazyReminder on their cell phone while shopping. As she is shopping, EazyMessage provides relevant offers that correlate to their shopping list. EazyMessage also can provide them with virtual coupons on items in their EazyReminder list. When the EazyReminder is not functioning EazyMessage continues to present relevant content.

Both EazyMessage and EazyReminder can allow the user to enable EazyPeek within their EazyMessage or EazyReminder window. Again this feature allows the user to take a peek at a webpage without having to open a new browser and/or click the back button. When the user hovers their mouse over the EazyMessage or EazyReminder window the correlating webpage (if there is one in the window) will open a window that crosses the entire computer screen but only provides a small horizontal look at the webpage. The user can scroll down the page to quick peek and scan the content. If they decide the webpage is of value to their experience they can click in the EazyPeek window and the full webpage pops up in a new browser.

The EazyReminder program can be provided on computers, cell phones, PDA's, or other types of personal electronic devices. A user can create reminders using EazyReminder on her desktop or laptop computer and have the reminders sent to her cell phone and vice-versa. This simply requires that the user has enabled the EazyReminder software on all machines that she wishes to see their EazyReminder. If the reminders are date and time sensitive, the user can also have them automatically sent to a daytimer (calendar) software, and EazyReminder will make an entry on this date and time into their day planning software also leaving an EazyReminder icon that is date and time stamped as to when their EazyReminder was sent. The user can also send a message from their calendar software directly into their EazyReminder rotation by simply clicking on the EazyReminder toolbar that the user has downloaded into their calendar software. Again EazyReminder can also be used to remind a user of bill payments. EazyReminder can also be used by merchants both on their website and in their downloads allowing their customers to receive EazyReminders of bill payments, due dates, service schedules, doctor and dentist appointments, etc. The user must opt in to receive messages from any merchant, association, service, or club. When a user clicks on an EazyReminder for a bill payment the user is then taken to the EazyPayment landing page where the user can choose to pay their bill and allow EazyPayment to automatically process their payment and provide all parties to the transaction a record of their payment. This can allow a user to pay bills in real time when they are away from home, as they can be reminded and pay with just two clicks of their mouse, or cell phone, or PDA. A user may also choose to receive their EazyReminder in the form of an email, rather than a visual EazyReminder. This may occur when a user does not have a high-speed Internet connection.

The user who is busy on the road and only has a cell phone or PDA, or any other device to connect to the internet, may choose to simply have an EazyReminder tune play to remind them of a specific task, duty, function. The user can assign a specific tune to any EazyReminder. The user can choose tunes that are specific to the EazyReminder (e.g. “Happy Birthday” to remember a birthday or to buy a birthday present, “Take me out to the Ballgame” to remember a child's baseball game, or any other event related tune), or the user may choose a tone that is related directly to the EazyReminder (hearing a tune with a voice over with the name of their car dealership, reminding them it's time to change the oil). The user is the filter for these reminders meaning, the user sets their own EazyReminder playlist. The user can receive as many or as few EazyReminder tunes as they wish. Again these EazyReminders can be loaded into the users EazyReminder playlist from any device, and can be accessed by any device, as long as the device has EazyReminder loaded. EazyReminder functions in all software, on all operating systems, and on any Internet device.

Advertising Methods using EazyMessage

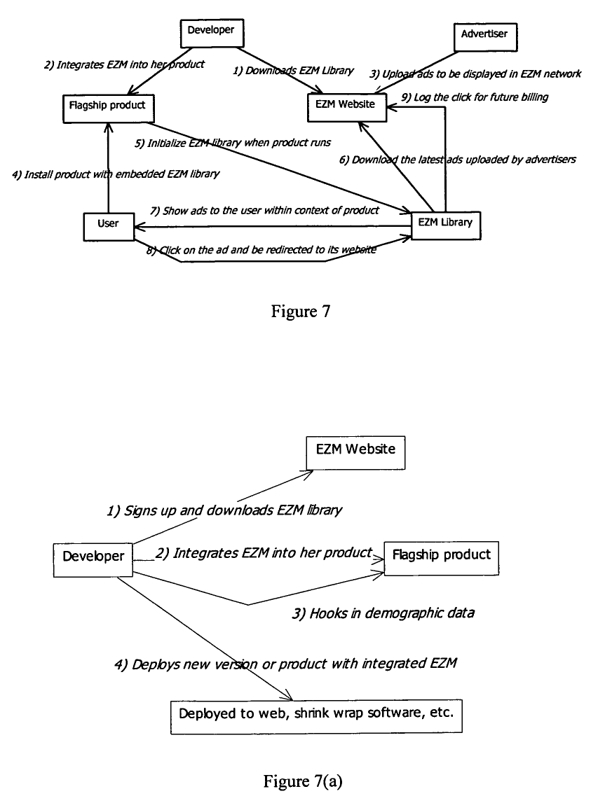

As described earlier, EazyMessage can be used to deliver advertisement. A source that sends messages to a computer running EazyMessage is referred to as an EazyMessage sender. In the following descriptions, the terms advertisement and advertiser are used to refer to information delivered to the users and the sender of the information, whether or not the messages are commercial in nature. Thus, “advertisers” may include associations, clubs, etc. as well as the traditional advertisers. FIG. 7 shows an advertising system and method using EazyMessage. EazyMessage (implemented as the EazyMessage library or “EZM library”) is integrated into a software program developed by a software developer (the “flagship product”), and is installed on a user's computer when the flagship product is installed. Advertisers interact with an ad management website (“EZM website”) to deliver ads to the user via the EZM webpage and the EazyMessage library on the user's computer.

FIG. 7(a) illustrates a process by which a software developer integrates EazyMessage library into its software product (the “flagship product”). The software developer creates an account through the EazyMessage website and downloads the EazyMessage library (step 1). The developer integrates the EazyMessage library using standard and known techniques of hosting ActiveX controls within the flagship product (step 2). The developer hooks in the demographic data that the flagship product collects as part of the tasks it performs on behalf of the user (step 3). When the next version of the flagship product is launched, it will contain the EazyMessage window. Targeted ads that correspond to the demographics of the user will be downloaded every time the EazyMessage window launches (i.e. every time the container flagship product launches) (step 4). Flagship product users now notice a window that contains tasteful advertising that is relevant to their demographics. They click on the ad and are redirected to the advertiser's website.

More specifically, once the developer positions the EazyMessage window to the desired position in his application, the sequence diagram of FIG. 7(c) is followed. First, the user starts the developer's product. The product calls EazyMessage's Initialize function. Then, EazyMessage gets the latest ads and/or messages (collectively referred to as “ads” here) from the ad server through a standard, http web connection. This call is preferably asynchronous so as to not block the product's initialization sequence. Optionally, when the new ads are downloaded, the EazyMessage library verifies that the ads are signed by the ad server through its digital signature. If the ad signature does not verify, they are discarded. (This prevents viruses inserting their own ads into the display window, as they do not have a digital signature provided by the ad server). The EazyMessage library compares the new ads' date to the ads that were last downloaded from the server. If the ads are new, the existing ads are replaced with the new ads so that they become part of the messages to be displayed in the message window. The EazyMessage library then displays its ads in its window on a rotating basis. In one embodiment, the ads are filtered on the user computer so that only the ads that conform to the demographic profile stored on the computer will be shown. Assuming that the user views ads in the EazyMessage window, and at some point in the future, the user clicks on an ad. Since the ads are displayed in the EazyMessage window and the component is a “window within a window”, then it can react directly to the user click without the need for further parent program interaction. The EazyMessage library opens a browser and browses to the ad server, telling it which ad was clicked. Optionally, the ad server increments a click count for the ad which may be used for Cost Per Click advertiser billing. The ad server also redirects the user's browser to the ad landing page.

FIG. 7(b) illustrates a process by which an advertiser displays its ads using the EZM website and EazyMessage. The advertiser creates an account through the EZM website and downloads, installs and runs the EazyMessage Wizard. After the advertiser uploads his ads, the ads may be checked by a human operator for approval according to editorial policies, and uploaded into the EZM server. EZM installations around the world will contact this server to download the latest ads; thus, ad distribution is automatic refreshed on a daily basis.

The EazyMessage technology provides a control panel for the EazyMessage sender (such as an advertiser, an association, etc. that wishes to communicate with the user) to broadcast their messages. The EazyMessage control panel allows the sender to choose the message recipients by group, geographical location, college major, or any other demographic, or psychographic field provided by the EazyMessage viewer. To accomplish this, EazyMessage has a sender interface to deploy the sender's messages.

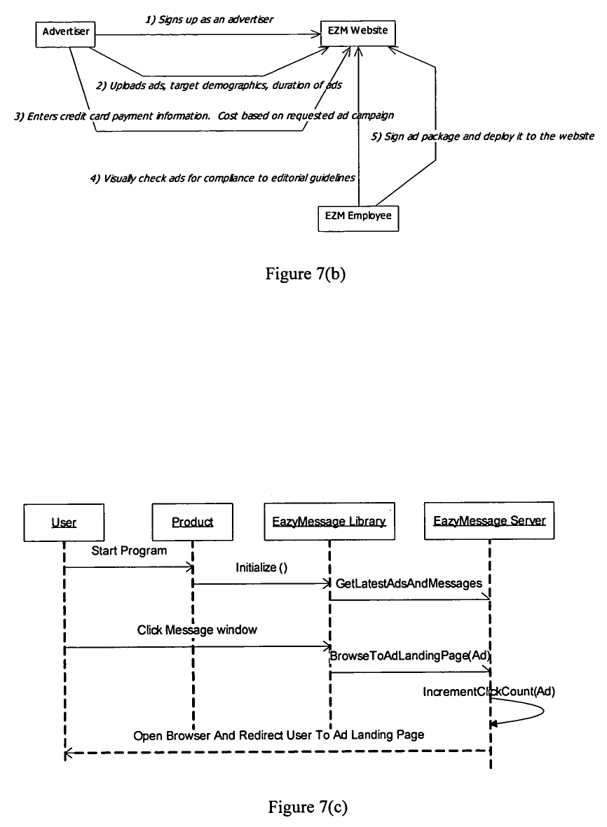

When the EazyMessage window displays an ad, the use may click on the ad and be redirected to the advertiser's website. Various methods can be employed so that both the owner of the ad management website and the software developer will receive ad revenue. FIG. 8 illustrates a process by which the EazyMessage library interacts with the user and the EZM website to deliver ads to the user and to facilitate the user's interaction with the advertiser. First, the user downloads or purchases a program that contains the EZM library (step 1). The user launches that program (step 2), and the program initializes the EZM library (step 3). The EZM library connects to the EZM website and downloads the latest ad package into the browser cache (step 4). If the browser cache already has the latest ads, then the download is skipped. The EZM library checks the digital signature of the ad package to ensure that it was signed by the EZM website, and that the package has not been tampered with. This step (which is optional but preferred) ensures that no one can serve EazyMessage ads unless they were explicitly verified and checked by the EazyMessage website. The EazyMessage library filters which ads should be shown within the program based on the user's demographic profile (step 5). EazyMessage reads this encrypted file to filter out ads which do not fit the advertiser's targeted demographic profile. In a preferred embodiment, this filtering process happens only on the client machine, and thus no personal information is transmitted to the EazyMessage website; thus protecting the user's privacy. Of the selected ads, EazyMessage reads the duration, order, start date, and end date of the ad, which are all variables entered by the advertiser and securely encoded in the EazyMessage ad package. The EazyMessage library displays the ads to the user (step 6). The display may use a fade in/fade out effect. When the user clicks on an ad, she is redirected to the ad's website which was set by the advertiser (step 7). The EazyMessage library logs the click for future per-click billing of the advertiser, and per-click royalties for the developer of the flagship product software (step 8). Various revenue schemes can be used as among the advertiser, the EazyMessage library developer, the EazyMessage website owner, the software developer, etc. Preferably, aggregate click counts and billing information for both the advertiser and the software developer are viewable by logging into the EazyMessage website. Steps 4-8 are executed by the EazyMessage library in the background without freezing the program that contains it.

In the methods described above, the users' personal information is kept confidential and not revealed to third party advertisers. Advertisers send messages to users based on the users' general profile. A user's profile is based on personal information provided by the user. This personal information is used to create a profile for each user (which includes, for example, age range, gender, college, major, etc., but does not include personally identifiable information, such as social security number, address, etc.), which in turn categorizes the individual into a group or groups. EazyMessage allows advertisers to select groups to whom they would like to advertise. The EazyMessage control panel allows advertisers to control their entire ad campaign. As EazyMessage control panel is automated, this allows advertisers to create their own messages, set their own budgets, target their audience, and control all aspects of a campaign (duration, mix of messages within the campaign, etc.).

In one embodiment, all ads from an advertiser are downloaded to a user's computer, and the ads are filtered by the program residing on the computer and selectively displayed to the user. An advantage of this method is that the EazyMessage website and the advertisers are not provided with any information about the user, thereby better protecting the user's privacy. This method also alleviates the security requirements for the EazyMessage website, as it does not store any demographic or private information. Another advantage is that it lessens the computation load on the EazyMessage website. In an alternative embodiment, demographic data and other data about the user is sent to the EazyMessage website, which filters the ad and selectively download a subset of targeted ads to the user. Disadvantages of this method include a lower level of protection of the users' privacy and increased the computation load of the EazyMessage website.

As an alternative to filtering the ads by demographic profiles, the program can simply display all the ads from an advertiser or advertisers or a selection of those ads. This method is less preferred because the ads are less relevant to the user and therefore less effective.

The demographic information used to filter ads in step 5 of FIG. 8 may be collected by the EazyMessage program. During the regular course of working with a software program that integrates EazyMessage, the user may volunteer demographic information. This demographic information is forwarded to the EazyMessage library which stores it in an encrypted file. Since there can be multiple software programs that integrate with the EazyMessage library, and each program can collect a different subset of demographic information (for example, financial information entered into accounting or tax related programs, educational information entered into academic related applications), EazyMessage can aggregate this demographic information into the encrypted file to create a more complete demographic profile that is valuable to advertisers.

EazyMessage can display ad messages even when a user's computer is not connected to a network (e.g. the Internet), i.e., when the user is off-line. When EazyMessage is initialized, it attempts to download the latest ads from the EZM server over the Internet. If there is no Internet connection, then EazyMessage will use the last ad package that it successfully downloaded. To prevent tampering with this ad package (e.g. a virus writer attempting to show his own ads), an ad package's digital signature is always checked before running the ads in the package. If it does not check ok, then EazyMessage will download the latest ads from the server, and check the digital signature again before showing the ads. If EazyMessage does not have a valid ad package, and cannot download a new one from the EZM server, then it displays a default, static ad which is shipped as part of the EazyMessage library. Further, when the computer is connected to the server, EazyMessage may download and cache, in addition to the messages, landing pages for the messages, which are pages that contain additional information related to the messages. When the user clicks on a displayed messages and the user is currently off-line, the user is redirected to the cached landing page which provides more information related to the clicked message.

The EazyMessage programs on user computers may be connected to either a single ad server or multiple ad servers. Multiple ad servers provide enhanced performance and reliability. Through the ad server, advertising space may be sold to advertisers on a bidding system, and the contract price paid by the advertiser may depend on the duration, demographic coverage, start date, end date, order of the ads, etc.

EazyMessage also includes technology to avoid spamming of emails with EazyMessage. EazyMessage can set a threshold on the number of messages that can be sent from an email in a specified unit of time (per hour/day/week/etc.), also, there is a per fee message option that can be deployed to avoid EazyMessage being used for spam.

It should be noted that EazyMessage is not Spyware, and does not include Spyware. For example, EazyMessage does not use a counter to count how many pages users have visited and then credits users with a free ad of their own. EazyMessage therefore is free of spying on the user.

Advantages and Practical Applications of EazyMessage

EazyMessage provides unique benefits for both the user and the advertiser. For the user, EazyMessage provides a non-intrusive tool for communication. EazyMessage allows the user to work in their chosen environment without being disrupted by annoying popups, popunders, or the annoyance of spyware that results in email inboxes being spammed. The user can receive more information at their choosing, as EazyMessage allows the user to click on the message/ad and be taken to a landing page, without having them leave their original environment. EazyMessage allows the computer user to be more efficient and effective with the space on their computer screen.

EazyMessage and EazyReminder can be utilized like other traditional advertising vehicles (per impression, or per click, whereby the advertiser provides artwork and the as server incorporates this into a standard universal playlist) but the EazyMessage and EazyReminder technology provides a unique backend which includes a self-serve Control Panel that allows the advertiser to control the frequency, target audience (by geography, demographic, etc.), and campaign.

EazyMessage has many advantages over existing technologies, as highlighted below.

Existing technology spies on users. As mentioned above EazyMessage uses non-specific (e.g. age range, college) information that allows EazyMessage to create a user profile, ad advertisers can select groups. EazyMessage does spy on the user.

Existing technology does not provide a dynamic, streaming, environment with both audio and video capabilities. EazyMessage is an aesthetically superior improvement on current technology.

Existing technology does not provide advertising/messaging capabilities in environments other than web browsers. Existing technology does not provide any advertising/messaging capabilities in the address bar, task bar, or any other position on the computer screen. EazyMessage provides more computer screen space for computer users.

EazyMessage and EazyReminder users can double opt which allows users to know when those on their list have logged into websites, messenger services, etc. EazyMessage allows users to know where their friends/family members are located at any given time on the Internet. EazyMessage allows users to know who on their EazyMessage list is currently online. While this capability is not new as other messenging software is capable of doing this, EazyMessage allows users to create message to be seen and heard by them when those on their list visit a specific site (e.g. a chat site, or any other site that is of interest to them).

It will be apparent to those skilled in the art that various modification and variations can be made in the method of the present invention without departing from the spirit or scope of the invention. Thus, it is intended that the present invention cover modifications and variations that come within the scope of the appended claims and their equivalents.

What is claimed is:

1. A method implemented on a computer for displaying information to a user, comprising:
(a) creating a functional bar area associated with a main window of an application program, the functional bar area including at least one message window;
(b) connecting the computer to a server via a network;
(c) in response to a user input of a search term, forwarding a search request to the server;
(d) receiving search results responsive to the search request and additional messages from the server, the additional messages having been selected by the server based on the search request;
(e) displaying the search results to the user; and
(f) displaying the additional messages in the message window in the functional bar area.

2. The method of claim 1, wherein the application program is a browser program.

3. The method of claim 1, wherein the application program is a non-browser program.

4. The method of claim 1, wherein the messages include text, images, graphics, animation, video, or audio messages.

5. The method of claim 1, wherein step (d) includes receiving a plurality of additional messages from the server, the method further comprising:
(g) storing the plurality of additional messages received from the server; and
(h) displaying the stored plurality of additional messages in the message window in the functional bar area when the computer is disconnected from the server.

6. The method of claim 5, wherein the plurality of additional messages are displayed sequentially.

7. The method of claim 1, further comprising:
(i) storing user profile information on the computer; and
(j) filtering the received additional messages based on the stored user profile information before the displaying step (f).

8. The method of claim 1, further comprising receiving a search term from a user, including:
in response to a pointing device of the computer being placed over a content in the main window, obtaining text representing the content as the search term.

9. The method of claim 8, wherein the content is text and the text is used as the search term.

10. The method of claim 8, wherein the content is image, graphics, or video, and wherein code behind the image, graphics, or video is read and the search term is automatically selected from the code.

11. The method of claim 1, further comprising:
in response to a user input, changing a size or shape of the message window.

12. A method implemented on a system including a server and one or more client computers connectable to the server via a network, the method comprising:
on each client computer:
(a) creating a functional bar area associated with a main window of an application program, the functional bar area including at least one message window;
(b) connecting the computer to the server via the network;
(c) in response to a user input of a search term, forwarding a search request to the server;
(d) receiving search results responsive to the search request and additional messages from the server, the additional messages having been selected by the server based on the search request;
(e) displaying the search results to the user; and
(f) displaying the additional messages in the message window in the functional bar area; and
on the server:
(g) obtaining and storing a plurality of messages from a plurality of message senders;
(h) receiving a search request from a client computer;
(i) obtaining search results responsive to the search request;
(j) selecting, from the plurality of stored messages, a subset of messages based on the search request; and
(k) transmitting the search results and the subset of messages to the client computer.

13. The method of claim 12, further comprising:
on the server:
(l) storing user demographic profile information associated with each client computer;
wherein the selecting step (j) is further based on the user demographic profile information associated with the client computer.

14. The method of claim 13, further comprising:
on the server:
(m) receiving control information from a message sender defining a target user demographic profile;
wherein the selecting step (j) is further based on a comparison between the target user demographic profile defined by the message sender and the user demographic profile information associated with the client computer.

15. The method of claim 12, further comprising:
on each client computer:
storing user profile information; and
filtering the received additional messages based on the stored user profile information before the displaying step (f).

16. A method implemented on a computer for displaying information to a user, comprising:
(a) creating a functional bar area associated with a main window of a non-browser application program, the functional bar area including at least one message window;
(b) connecting the computer to a server via a network;
(c) receiving messages from the server; and
(d) displaying the messages in the message window in the functional bar area.

17. The method of claim 16, wherein the information is text, images, graphics, animation, video or audio messages.

18. The method of claim 16, further comprising:
in response to a user input, changing a size or shape of the message window.

19. A method implemented on a computer system comprising at least one sender client computer, at least one receiver client computer and at least one server, the method comprising:
(a) the sender client computer transmitting to the server a first message and control information associated with the first message specifying intended recipient or recipients of the first message;
(b) the server storing the first message and the associated control information; and
(c) on the receiver client computer:
(c1) creating a functional bar area associated with a main window of an application program, the functional bar area including at least one message window;
(c2) connecting the receiver client computer to the server via a network;
(c3) receiving messages from the server; and
(c4) displaying the messages in the message window in the functional bar area.

20. The method of claim 19, wherein the control information associated with the first message identifies one or more intended recipients, and
wherein in step (c3), the receiver client computer receives the first message if it is one of the one or more intended recipients.

21. The method of claim 19, wherein the control information associated with the first message specifies a demographic profile of intended recipients, and
wherein in step (c3), the receiver client computer receives the first message if it has a profile satisfying the demographic profiled specified by the control information.

22. The method of claim 19, wherein in step (a), the control information identifies the sender client computer itself as the intended recipient and further specifies a condition for message delivery;
wherein in step (c) the receiver client computer is the sender client computer, and wherein in step (c3) the first message is received if the condition for message delivery is met.

23. A method implemented on a computer for displaying information to a user, comprising:
(a) creating a functional bar area associated with a main window of an application program, the functional bar area including at least one message window;
(b) connecting the computer to a server via a network;
(c) receiving a plurality of messages from the server;
(d) displaying at least a subset of the received messages in the message window in the functional bar area;
(e) storing the received messages; and
(f) displaying at least a subset of the stored messages in the message window in the functional bar area when the computer is disconnected from the server.

24. The method of claim 23, wherein in each of steps (d) and (f) the messages are displayed sequentially.

25. The method of claim 23,
wherein step (c) further comprises receiving from the server a plurality of landing pages associated with the respective messages;
wherein step (e) further comprises storing the landing pages;
the method further comprising:
(g) in response to a user input identifying a displayed message, displaying the landing page associated with the identified message.

26. A method implemented on a computer for displaying information to a user, comprising:
(a) creating a functional bar area associated with a main window of an application program, the functional bar area including at least one message window;
(b) connecting the computer to a server via a network;
(c) receiving a plurality of messages from the server;
(d) storing user profile information; and
(e) filtering the received plurality of messages based on the stored user profile information to select a subset of the messages to be displayed;
(f) displaying the selected subset of messages in the message window in the functional bar area.

27. The method of claim 26, further comprising:
generating the user profile information by collecting information while executing the application program.
